(19) United States
(12) Patent Application Publication
(10) Pub. No.: US 2025/0387964 A1
(43) Pub. Date: Dec. 25, 2025

(54) Multiplexed extrusion system

(71) Applicant: UT-Battelle, LLC, Oak Ridge, TN (US)

(72) Inventors: Halil Tekinalp, Knoxville, TN (US); Alex C. Roschli, Knoxville, TN (US); Jesse Heineman, Knoxville, TN (US); Vipin Kumar, Knoxville, TN (US); Soydan Ozcan, Oak Ridge, TN (US); Brian K. Post, Knoxville, TN (US); Paritosh S. Mhatre, Knoxville, TN (US); Umesh N. Marathe, Knoxville, TN (US)

(73) Assignee: UT-Battelle, LLC, Oak Ridge, TN (US)

(21) Appl. No.: 19/244,622

(22) Filed: Jun. 20, 2025

Related U.S. Application Data
(60) Provisional application No. 63/662,624, filed on Jun. 21, 2024.

(51) Int. Cl. B29C 48/16; B29C 48/05; B29C 48/30; B29C 48/335

(52) U.S. Cl. CPC B29C 48/16; B29C 48/05; B29C 48/304; B29C 48/335

(57) ABSTRACT

A multi material extrusion system includes a first polymer extruder configured to extrude a first polymer, and a second polymer extruder configured to extrude a second polymer. A nozzle includes a first polymer inlet in fluid connection with the first extruder, a second polymer inlet in fluid connection with the second extruder, and a merging nozzle conduit having a merging nozzle conduit surface. The merging nozzle conduit terminates in a merging nozzle conduit outlet opening. The nozzle further includes a first polymer flow conduit in fluid communication with the first polymer inlet and a second polymer flow conduit in fluid communication with the second polymer inlet. The first polymer flow conduit is configured to deliver the first polymer to the merging nozzle conduit and the second polymer flow conduit is configured to deliver the second polymer to the merging nozzle conduit, to create a multi-material bead comprising the first polymer in contact with the second polymer.

### CROSS-REFERENCE TO RELATED APPLICATIONS

This application claims priority to U.S. Provisional Patent Application No. 63/662,624 filed on Jun. 21, 2024, entitled “MULTIPLEXED EXTRUSION SYSTEM”, the entire disclosure of which incorporated herein by reference.

### STATEMENT REGARDING FEDERALLY SPONSORED RESEARCH AND DEVELOPMENT

This invention was made with government support under Contract No. DE-AC05-00OR22725 awarded by the United States Department of Energy. The government has certain rights in this invention.

### FIELD OF THE INVENTION

The present invention relates to additive manufacturing, and more particularly to extrusion systems and nozzles for additive manufacturing and other extrusion-based processes.

### BACKGROUND OF THE INVENTION

As additive manufacturing printers get larger, there is a need for larger extruders with high throughput to quickly construct objects. Extruders can continually be made larger, but the mass of the extruder grows more quickly than the output of the extruder. Large heavy extruders require a stiffer and more expensive gantry or robot to manipulate them. These extruders also struggle with unreliable flow below approximately 10% of the maximum flow rate, causing control issues for small builds and low speed printing operations. Conventional multi material extrusion and printing are based on the extrusion of different materials where the different materials are extruded one at a time.

### SUMMARY OF THE INVENTION

A multi material extrusion system includes a first polymer extruder configured to extrude a first polymer, and a second polymer extruder configured to extrude a second polymer. A nozzle comprises a first polymer inlet in fluid connection with the first extruder, a second polymer inlet in fluid connection with the second extruder, and a merging nozzle conduit having a merging nozzle conduit surface. The merging nozzle conduit terminates in a merging nozzle conduit outlet opening. The nozzle can further include a first polymer flow conduit in fluid communication with the first polymer inlet and a second polymer flow conduit in fluid communication with the second polymer inlet. The first polymer flow conduit can be configured to deliver the first polymer to the merging nozzle conduit and the second polymer flow conduit can be configured to deliver the second polymer to the merging nozzle conduit, to create a multi-material bead comprising the first polymer in contact with the second polymer. The second polymer can be the same or different from the first polymer.

At least one of the first polymer and second polymer can include elongated fibers. Fiber alignment structure can be provided in the merging nozzle conduit for aligning the elongated fibers in a common direction. The fiber alignment structure can comprise elongated baffles affixed to the merging nozzle conduit surface and aligned in a direction of flow of the first polymer and second polymer through the merging nozzle conduit. The fiber alignment structure can comprise concentric flow channels within the merging nozzle conduit and aligned in a direction of flow of the first polymer and the second polymer through the merging nozzle conduit.

The multi material extrusion system can include a processor. The processor can be used to control functions of the system such as polymer feed rates, extruder operation, nozzle operation, and positioning of the nozzle.

The multi material extrusion system can include a first polymer source in communication with the first polymer extruder, and a second polymer source in fluid communication with the second polymer extruder. The first polymer source and the second polymer source can be containers adapted for polymer pellets.

The first polymer flow passageway, the second polymer flow passageway and the merging nozzle conduit can be Y-shaped. The first polymer flow passageway, the second polymer flow passageway and the merging nozzle conduit can be T-shaped. Many other shapes are possible.

The nozzle can include a nozzle block comprising the first polymer flow conduit, the second polymer flow conduit, and the merging nozzle conduit. The nozzle can further include a nozzle tip comprising the nozzle tip opening. The nozzle tip can be fixed to the nozzle block so as to place the nozzle tip opening in fluid communication with the merging nozzle conduit outlet opening. The nozzle tip can be detachable from the nozzle block. The nozzle tip can be rotatable relative to the nozzle block.

The first polymer flow passageway and the second polymer flow passageway can transition to concentric outlet polymer flow passageways at the merging nozzle outlet. The first polymer flow passageway and the second flow passageway can transition to concentric outlet polymer passageways with the first outlet polymer passageway surrounding the second outlet polymer passageway, and the second outlet polymer passageway terminating in a forming plate comprising a plurality of flow openings communicating with flow tubes such that polymer rods of the second polymer are formed as the second polymer passes through the flow tubes. The first polymer flows from the first outlet polymer passageway around the flow tubes to form a filament of the first polymer with embedded rods of the second polymer at the merging nozzle outlet opening.

The multi material extrusion system can include a first helical guide affixed to the merging nozzle conduit surface for directing at least one of the first polymer and the second polymer in a helical path through the merging nozzle conduit. A second helical guide can be affixed to the merging nozzle conduit surface and arranged relative to the first helical guide in a double helical configuration.

The nozzle can comprise a rotating nozzle tip. The rotating nozzle tip can include a nozzle tip conduit in fluid communication with the merging nozzle conduit outlet opening. The nozzle tip can further include a guide plate fixed within the nozzle tip conduit so as to rotate with the nozzle tip, the guide plate comprising a plurality of guide openings.

A method of multiplexing extrusion, can comprising the steps of:
providing a first polymer extruder configured to extrude a first polymer, and a second polymer extruder configured to extrude a second polymer; a nozzle comprising a first polymer inlet in fluid connection with the first extruder, a second polymer inlet in fluid connection with the second extruder, and a merging nozzle conduit having a merging nozzle conduit surface, the merging nozzle conduit terminating in a merging nozzle conduit outlet opening; the nozzle further comprising a first polymer flow conduit in fluid communication with the first polymer inlet and a second polymer flow conduit in fluid communication with the second polymer inlet;
delivering the first polymer to the first polymer flow conduit and to merging nozzle conduit from the first extruder;
delivering the second polymer to the second polymer flow conduit and to the merging nozzle conduit from the second extruder; and,
creating in the merging nozzle conduit a multi-material bead comprising the first polymer and the second polymer.

The method can further include the step of embedding the second polymer in the first polymer. The can further include the step of using a processor to control the positioning of the nozzle and the operation of the first polymer extruder and the second polymer extruder.

The multi plexing extrusion can be additive manufacturing, profile extrusion, additive manufacturing-compression molding (AMCM) processes, extrusion-compression molding processes, film and sheet extrusion processes, or blow molding processes. The merging nozzle conduit can receive polymer from at least 3 extruders, or virtually any number of extruders.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic diagram of an extrusion system according to the invention.

FIG. 2 is a cross section of an extruder and material source.

FIG. 3 is a front elevation cross sectional diagram of an extrusion nozzle.

FIG. 4 is a perspective cross sectional diagram of the extrusion nozzle of FIG. 3 in operation.

FIG. 5 is a front elevation cross sectional diagram of an extrusion nozzle for extruding core and sheath beads.

FIG. 6 is a perspective cross sectional diagram of the nozzle of FIG. 5 in operation.

FIG. 7 is an expanded view of area 7 in FIG. 6, partially in phantom.

FIG. 8 is a schematic perspective cross sectional diagram of an extrusion nozzle with a rotating nozzle tip extruding a braided bead.

FIG. 9 is a front elevation cross sectional diagram of the nozzle tip of FIG. 8.

FIG. 10 is a perspective cross sectional diagram of the nozzle tip of FIG. 8.

FIG. 11 is a front elevation cross sectional diagram of a merging nozzle conduit with a helical polymer guide.

FIG. 12 is a perspective view, partially in phantom, of a merging nozzle conduit of FIG. 11.

FIG. 13 is a perspective cross sectional diagram of the merging nozzle conduit of FIG. 13.

FIG. 14 is a front elevation cross sectional diagram of an extrusion nozzle with the merging nozzle conduit of FIG. 11.

FIG. 15 is a perspective cross sectional diagram of an extrusion nozzle with the merging nozzle conduit of FIG. 11.

FIG. 16 is a front elevation of the merging nozzle conduit of FIG. 11 in operation extruding a helical multi material bead.

FIG. 17 is a front perspective view of the merging nozzle conduit of FIG. 11 in operation extruding a helical multi material bead.

FIG. 18 is a partially exploded perspective cross sectional view of an alternative extrusion nozzle for extruding filaments of a first polymer embedded in a second polymer.

FIG. 19 is a cross section of a bead extruded by the extrusion nozzle of FIG. 18.

FIG. 20 is a front elevation cross sectional diagram of a merging nozzle conduit for extruding multi material polymer beads with aligned fibers.

FIG. 21 is a front perspective view of the merging nozzle conduit of FIG. 20, partially in phantom.

FIG. 22 is a front perspective cross sectional view of the merging nozzle conduit of FIG. 20.

FIG. 23 is a front elevation cross sectional view of a magnified portion of the merging nozzle conduit of FIG. 20 in operation.

FIG. 24 is a front perspective view of alternative fiber alignment structure for a merging nozzle conduit.

FIG. 25 is a front elevation cross sectional view of the fiber alignment structure of FIG. 24 in operation.

FIG. 26 is a front elevation cross sectional view of an alternative fiber alignment structure for a merging nozzle conduit in operation extruding a material with elongated fibers and another material without fibers.

FIG. 27 is a front elevation cross sectional view of the alternative fiber alignment structure for a merging nozzle conduit of FIG. 26 in operation extruding a material with elongated fibers and another material also with elongated fibers.

FIG. 28 is a front elevation cross sectional diagram of a detachable nozzle tip according to a first embodiment.

FIG. 29 is a front elevation cross sectional diagram of a detachable nozzle tip according to a second embodiment.

FIG. 30 is a front elevation cross sectional diagram of a detachable nozzle tip according to a third embodiment.

FIG. 31 is a front elevation cross sectional diagram of a detachable nozzle tip according to a fourth embodiment.

FIG. 32 is a front elevation cross sectional diagram of a detachable nozzle tip according to a fifth embodiment.

FIG. 33 is a front elevation cross sectional diagram of a detachable nozzle tip according to a sixth embodiment.

FIG. 34 is a front elevation cross section of a nozzle tip with a helical guide.

FIG. 35 is a perspective view of the nozzle tip of FIG. 34, partially in phantom.

### DETAILED DESCRIPTION OF THE INVENTION

A multi material extrusion system can include a first polymer extruder configured to extrude a first polymer and a second polymer extruder configured to extrude a second polymer. An extrusion nozzle includes a first polymer inlet in fluid connection with the first extruder, a second polymer inlet in fluid connection with the second extruder, and a merging nozzle conduit having a merging nozzle conduit surface. The merging nozzle conduit terminates in a merging nozzle outlet opening. The nozzle further comprises a first polymer flow conduit in fluid communication with the first polymer inlet and a second polymer flow conduit in fluid communication with the second polymer inlet. The first polymer flow conduit is configured to deliver the first polymer to the merging nozzle conduit and the second polymer flow conduit is configured to deliver the second polymer to the merging nozzle conduit, to create a multi-material bead comprising the first polymer and the second polymer. The second polymer can be the same or different from the first polymer to create a multi material extrusion bead.

The multi material extrusion system can be adapted to print extrusion beads where at least one of the first polymer and second polymer comprise elongated fibers. Fiber alignment structure can be provided in the merging nozzle conduit for aligning the elongated fibers in a common direction. The alignment structure can include radially arranged elongated baffles or fins affixed to the merging nozzle conduit surface and aligned in a direction of flow of the first polymer and second polymer through the merging nozzle conduit. The alignment structure can include concentric flow channels within the merging nozzle conduit and aligned in a direction of flow of the first polymer and the second polymer through the merging nozzle conduit.

The nozzle can comprise a merging nozzle outlet fitting. The merging nozzle outlet fitting can be detachable from the nozzle body. The merging nozzle outlet fitting comprises all or part of the merging nozzle conduit. Different structures can be provided in the merging nozzle outlet fitting in the flow path of the merging nozzle conduit to allow for different manipulations of the first and second polymer flows through the merging nozzle conduit, such as to create core and sheath beads, beads with embedded filaments or rods, and beads with aligned fibers and twisted or ribbon beads.

The nozzle can further comprise a nozzle tip. The nozzle tip can be fixed directly to the nozzle body. The nozzle tip can alternatively be attached to a merging nozzle outlet fitting. The nozzle tip comprises a nozzle tip outlet opening which functions as the merging nozzle outlet opening when a nozzle tip is present. The nozzle tip receives the extruded polymer flow streams and compresses and shapes the extruding beads as they leave the nozzle. The nozzle tip can be detachable from the nozzle body, or where present from the merging nozzle outlet fitting. This allows interchangeability of the nozzle tips and also ready access to the merging nozzle conduit for service and cleaning.

The multi material extrusion system can include a processor. The processor can be used to operate system components such as extruders, polymer sources, heaters, and nozzle tip rotation, among others.

The multi material extrusion system can include a first polymer source in communication with the first polymer extruder, and a second polymer source in fluid communication with the second polymer extruder. The first polymer source and the second polymer source can be containers adapted for polymer pellets. Although the invention is described with first and second polymer sources and extruders, any number of additional polymer sources and extruders are possible.

The first polymer flow conduit and the second polymer flow conduit can have different sizes and configurations, and can have the same size and configuration or different sizes and configurations. The first polymer flow conduit, the second polymer flow conduit and the merging nozzle conduit can be Y-shaped. The first polymer flow conduit, the second polymer flow conduit and the merging nozzle conduit can be T-shaped.

The first polymer flow conduit and the second flow conduit can transition in the merging nozzle outlet to concentric outlet polymer conduits with the second outlet polymer conduit surrounding the first outlet polymer conduit. This will form a core and sheath bead with the second polymer forming a sheath around a core of the first polymer. The first outlet polymer conduit can alternatively terminates in a forming plate comprising a plurality of flow openings communicating with flow tubes. The flow tubes form polymer rods of the first polymer as the first polymer passes through the flow openings. The second polymer flows from the second outlet polymer conduit around the flow tubes and can be pressed inwardly as it exits the second outlet polymer conduit to form a bead of the second polymer with embedded rods of the first polymer at the merging nozzle outlet opening.

The merging nozzle conduit can include a first helical guide affixed to the merging nozzle conduit surface for directing at least one of the first polymer and the second polymer in a helical path through the merging nozzle conduit. A second helical guide can be affixed to the merging nozzle conduit surface and arranged relative to the first helical guide in a double helical configuration.

The extrusion nozzle can include a rotating nozzle tip. The nozzle tip can include a nozzle tip conduit having a nozzle opening communicating with the merging nozzle conduit outlet opening. The nozzle tip can further include a guide plate fixed within the nozzle tip conduit so as to rotate with the nozzle tip. The guide plate can have a plurality of guide openings.

The extrusion system can be mounted on a suitable gantry or motorized support to move the nozzle according to a predetermined print. Printing movement of the nozzle and other commands can be controlled by processor. In cases where fine printing of reduced amounts of material is desired, one extruder can be turned off and one operated such that precise control is possible. Also, where large amounts of material are to be printed, for example in building construction prints or for large parts, multiple extruders can be used to feed polymer material to the nozzle. The system can be used with many different printing materials, including polymer material, cementitious materials, and others.

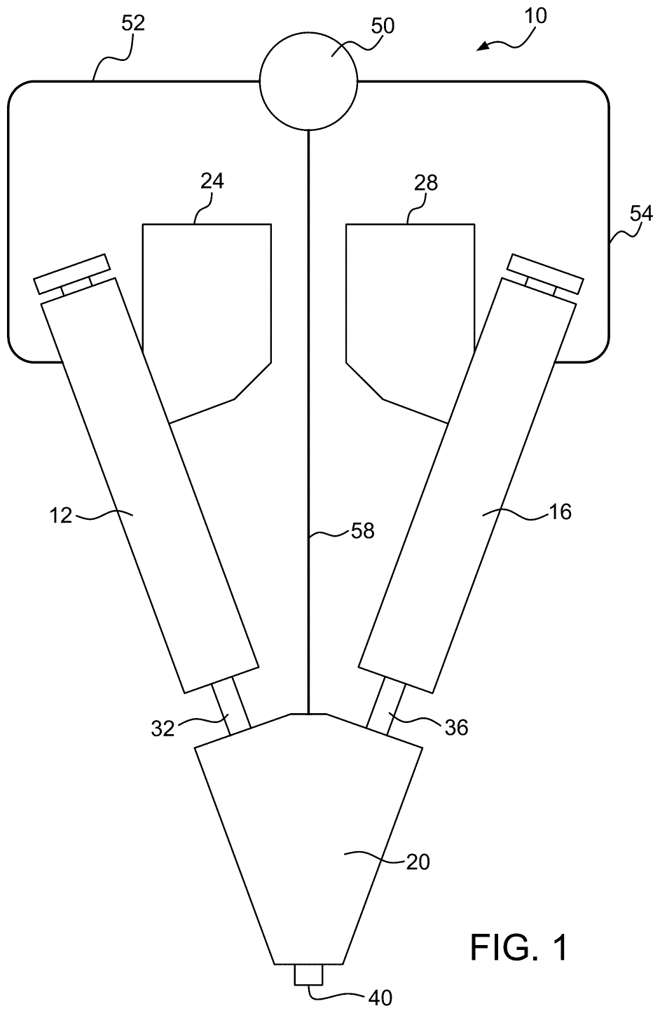

There is shown in FIGS. 1-4 an extrusion system 10 with a first extruder 12 and a second extruder 16 connected to an merging extrusion nozzle body 20. The system includes a first polymer extrusion material source 24 and a second polymer extrusion source 28. The first extruder 12 can be connected to the merging extrusion nozzle 20 through a first connection 32. The second extruder 16 can be connected to the merging extrusion nozzle 20 through a second connection 36. A nozzle tip 40 includes a merging nozzle outlet opening 42 for extruding a bead comprising both the first polymer material and the second polymer material. A processor 50 can be provided to control various operations of the extruder system. These can include, but are not limited to, the feed rate of the polymer material and the operations of the extruders 12 and 16. The merging extrusion nozzle body 20 can have components such as heaters and rotating nozzle tips the operation of which can also be controlled by the processor 50 through suitable connections 52, 54 and 58, which can be wired or wireless.

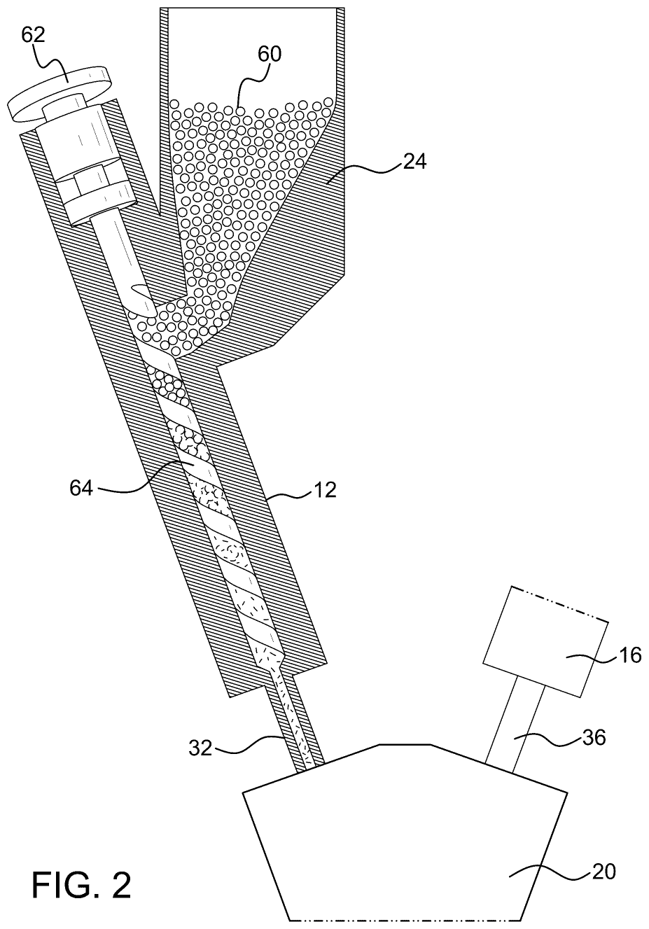

There is shown in FIG. 2 a first polymer material 60 in the first polymer extrusion material source 24 which is shown as a container but can also be a connection to a remote source. A suitable motor 62 can be operated to rotate and extruder screw 64 to move the material through the outlet connection 32 to the merging extrusion nozzle 20.

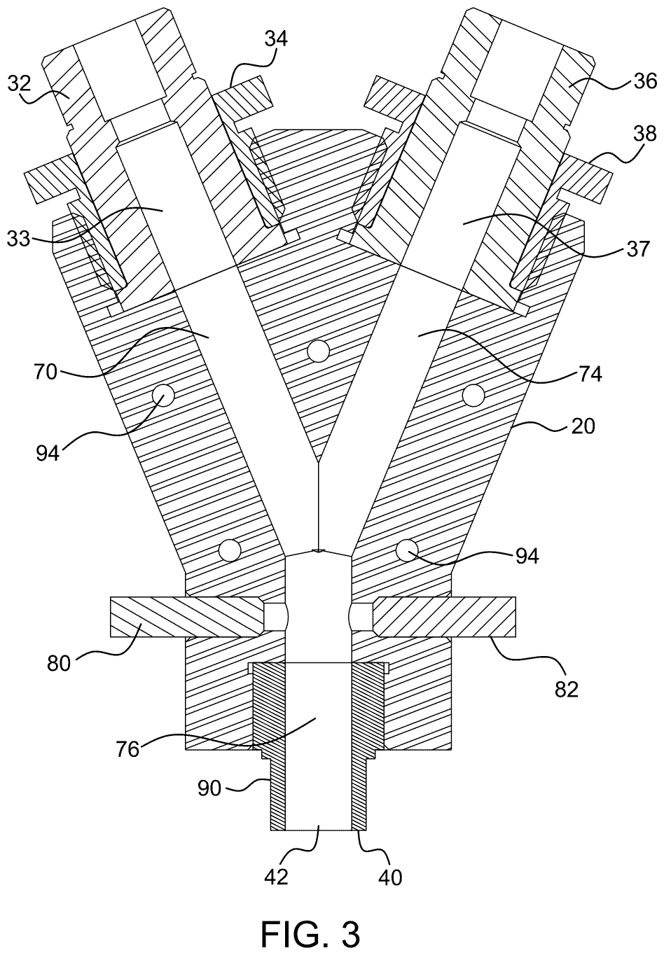

The merging extrusion nozzle 20 is shown in FIG. 3 to include a first fitting 34 to receive the first connection 32 and a second fitting 38 to receive the second connection 36. An interior conduit 33 of the first connection 32 communicates with a first polymer flow conduit 70 of the merging extrusion nozzle 20. An interior conduit 37 of the second connection 36 communicates with a second polymer flow conduit 74 of the merging extrusion nozzle 20. The first polymer flow conduit 70 and the second polymer flow conduit 74 communicate with a merging nozzle conduit 76. The merging nozzle conduit 76 can be wholly or partly contained in the nozzle body 20 or in a merging nozzle outlet fitting 90 which can be detachably connected to the rest of the nozzle body 20. The merging nozzle outlet fitting 90 can terminate in the nozzle end 40 and merging nozzle outlet opening, or in a separate nozzle tip which is secured to the merging nozzle outlet fitting 90 or directly to the nozzle body 20. The nozzle can include other features such as heater elements 94 to control the temperature of the merging polymer streams and pressure relief or access seals 80 and 82 to release over pressured polymer streams before damage to the extrusion system and surrounding area occurs, or to allow for serving and cleaning.

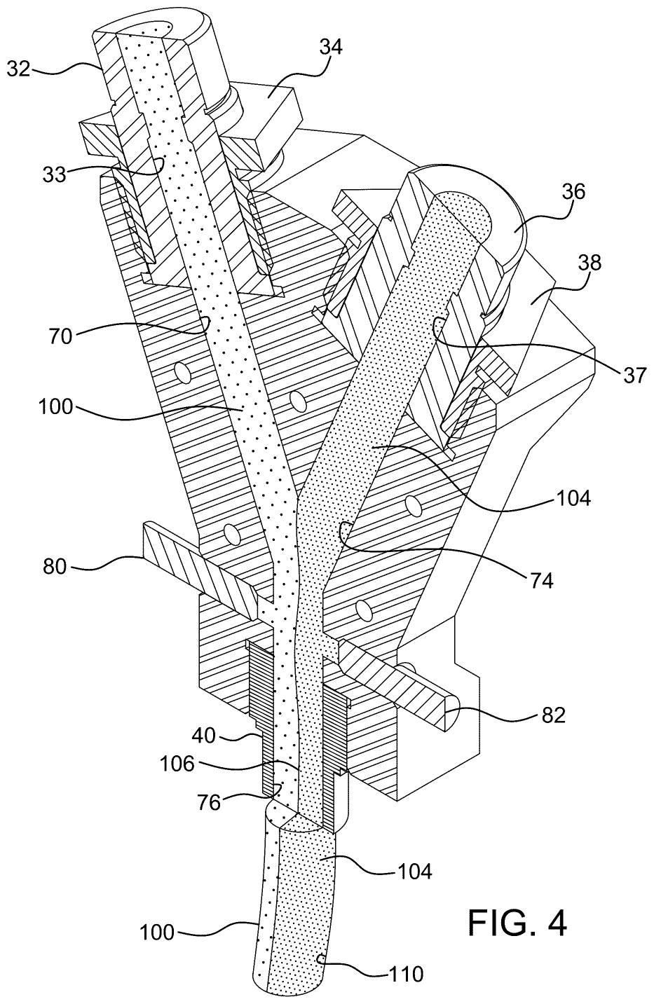

Operation of the merging extrusion nozzle is shown in FIG. 4. A first polymer stream 100 flows through the first polymer flow conduit 70. A second polymer stream 104 flows through the second polymer flow conduit 74. The two polymer streams merge in the merging nozzle conduit 76 that extends into and through the merging nozzle outlet fitting 90. The two streams contact at an interface 106 to form a bead 110 made up of the first polymer stream 100 and the second polymer stream 104.

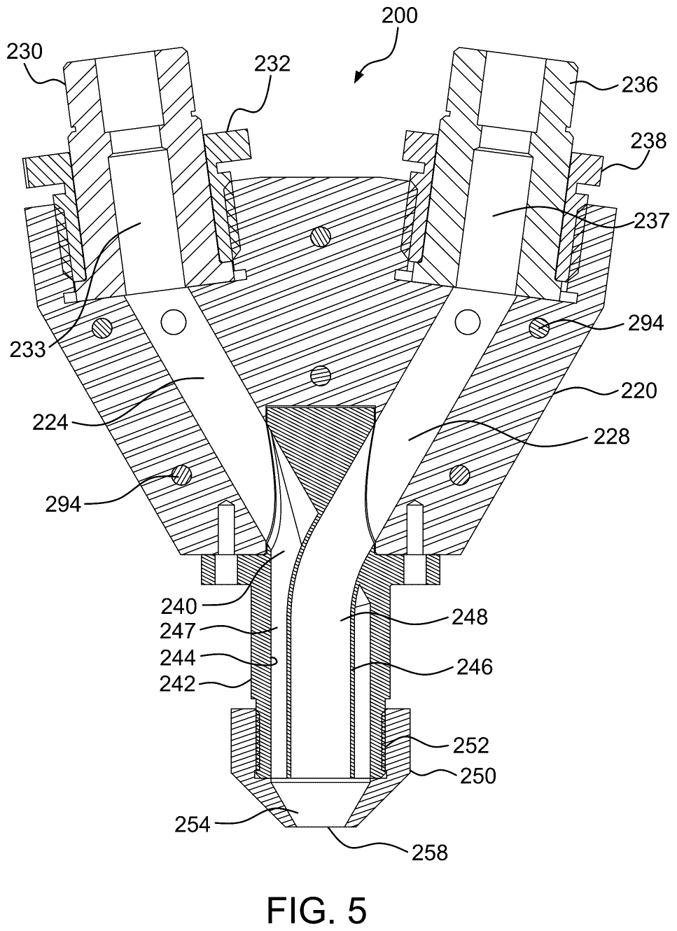

A core and sheath merging extrusion nozzle 200 is shown in FIGS. 5-7. The nozzle 200 includes a nozzle body 220 with a first polymer flow conduit 224 and a second polymer flow conduit 228. The first polymer flow conduit 224 communicates with a first connection 230 that is in communication with a first extruder (not shown). The first connection 230 can be secured to a fitting 232 and has an interior conduit 233 which communicates with the first polymer flow conduit 224. The second polymer flow conduit 228 communicates with a second connection 236 that is in communication with a second extruder (not shown). The second connection 236 can be secured to a fitting 238 and has an interior conduit 237 which communicates with the second polymer flow conduit 228. Heating elements 294 can be provided to maintain the polymers at a desired temperature as they flow through the merging extrusion nozzle 220.

The first polymer flow conduit 224 and the second polymer flow conduit 228 merge into a merging nozzle conduit 240. The merging nozzle flow conduit 240 can communicate with a merging nozzle outlet fitting 242 which has an open interior 247 defined by an interior wall 244. A core conduit 246 forms an interior 248 which communicates with the second polymer flow conduit 228. The core conduit 246 extends into the open interior 247 such that the open interior 247 is an annular opening surrounding the core conduit 246. A nozzle tip 250 can be secured to a distal end of the merging nozzle outlet fitting 242 at a distal end of the merging nozzle outlet fitting 242 by suitable structure such as threads 252. The nozzle tip 250 includes a nozzle tip interior 254 leading to a nozzle outlet opening 258.

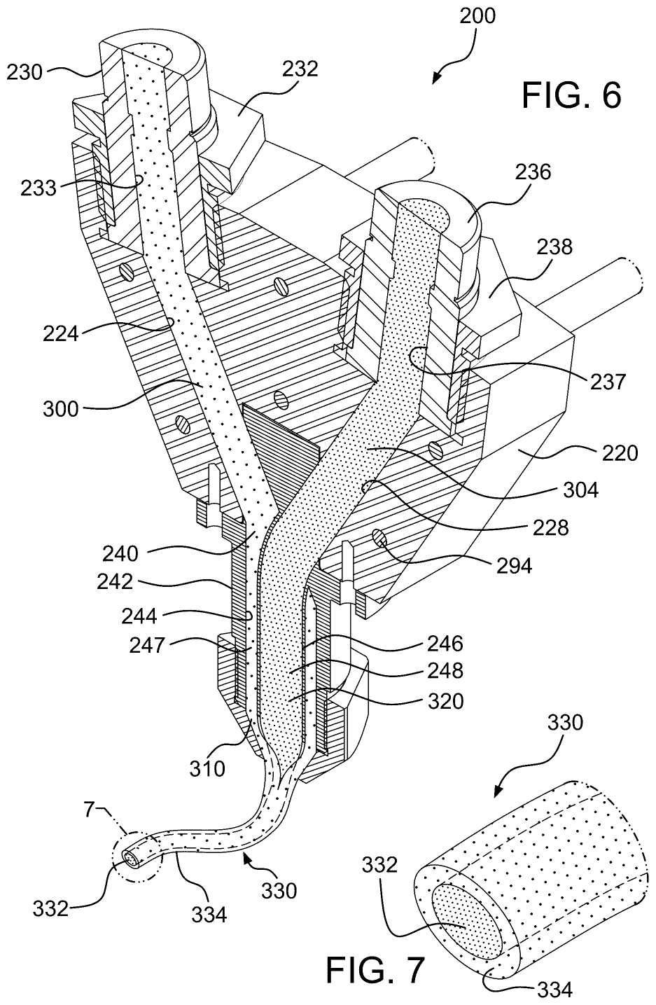

A first polymer 300 flows through the first polymer flow conduit 224 and a second polymer 304 flows through the second polymer flow conduit 228 until both reach the merging nozzle conduit 240, as shown in FIG. 6. There the two streams remain separated by the core conduit 246. The first polymer 300 flows through the annular interior 247 and surrounds the core conduit 246 as a tubular flow 310. The second polymer 304 flows through the core conduit 246 forming a cylindrical core 320. The tubular flow 310 and the cylindrical core 320 merge into physical contact in the interior 254 of the nozzle tip 250 and emerge from the nozzle outlet opening 258 as a bead 330 having a core 332 of the first polymer and a sheath 334 of the second polymer (FIG. 7).

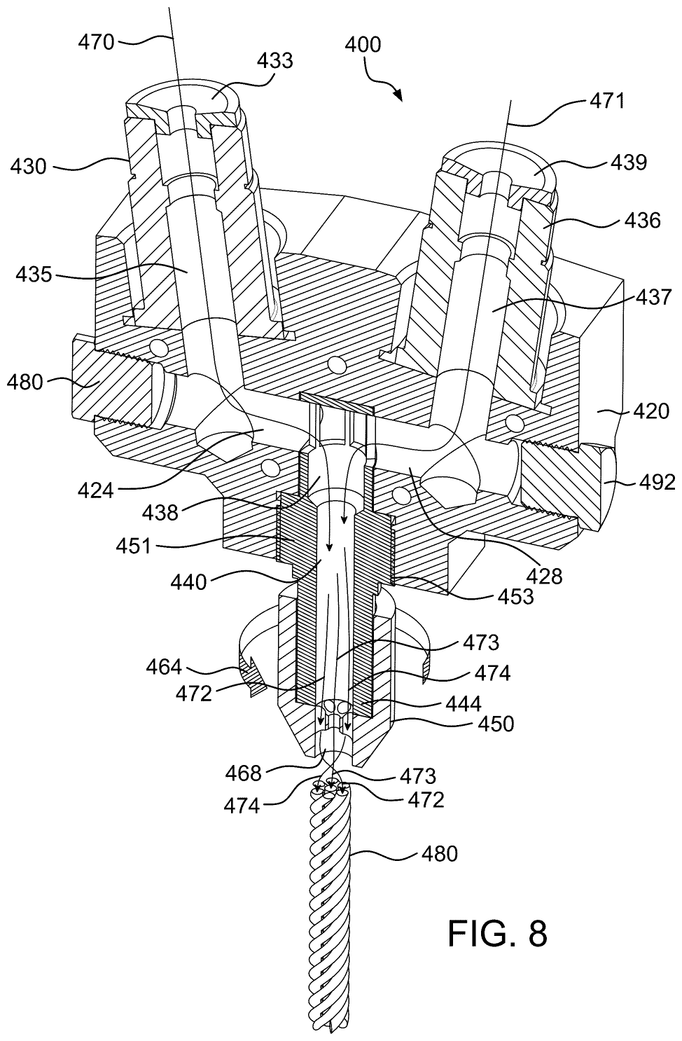

There is shown in FIGS. 8-10 a merging extrusion nozzle 400 that is suitable for preparing braided beads. The merging extrusion nozzle 400 can have a nozzle body 420. A first connection fitting 430 and cap 433 is provided for connecting to a first extruder (not shown) and to thereby receive a first polymer, and a second connection fitting 436 and cap 439 is provided for connecting to a second extruder (not shown) and to thereby receive a second polymer. The first polymer flows through an interior conduit 435 of the first connection 430 and into a branch conduit 424 as shown by arrow 470. The second polymer flows through an interior conduit 437 of the first connection 436 and into a branch conduit 428 as shown by the arrow 471. The first polymer and second polymer merge together in the merging nozzle conduit 438. The merging nozzle conduit 438 can be formed within a merging nozzle outlet fitting 444. The merging nozzle outlet fitting 444 can have a collar 451 which can engage the nozzle body 420 by suitable structure such as cooperating threads 453.

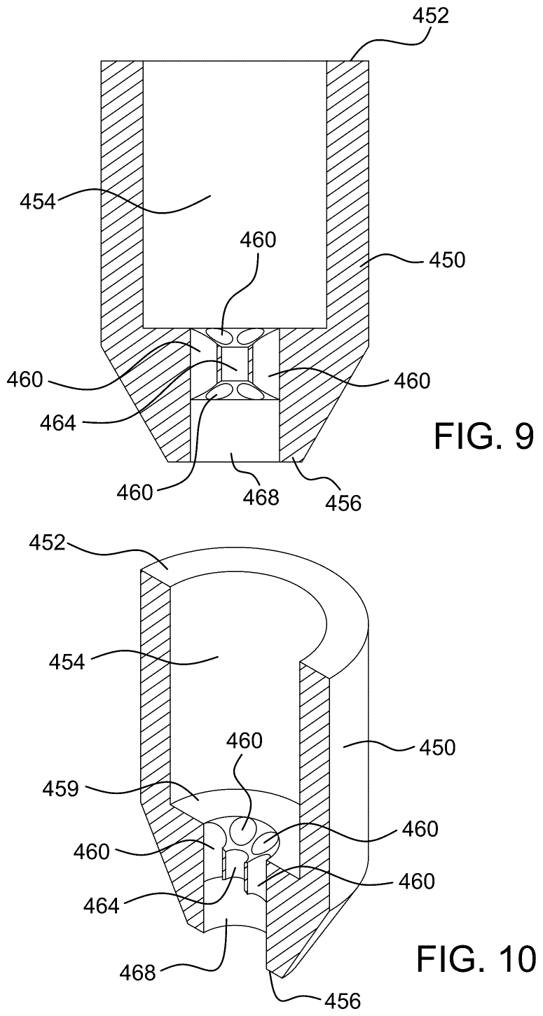

A rotating nozzle tip 450 can be joined to the distal end of the merging nozzle outlet fitting 444. The rotating nozzle tip 450 can have top 452, open interior 454 and distal end 456 (FIGS. 9-10). A guide 459 has a central aperture 464 and a plurality of surrounding apertures 460 distributed about the central aperture 464. The nozzle tip 450 has a nozzle outlet opening 468 at the distal end 456 from which the extruded bead emerges.

The first polymer and the second polymer merge and flow through an interior opening 440 of the merging nozzle outlet fitting 444. The flow through the merging nozzle outlet fitting 444 and the rotating nozzle tip 450 is illustrated by arrows 472-474 in FIG. 8. As the nozzle tip 450 rotates in the manner shown by the arrow 464, the flows illustrated by the arrows 472-474 enter the apertures 460 and 464 of the guide 469. The flow illustrated by arrow 473 passes through the central aperture 464 in substantially a straight path as illustrated. The rotation of the nozzle tip 450 causes the outside apertures 460 to rotate about the central aperture 464. Polymer flowing through these apertures is moved in a helical path as the bead is extruded as illustrated by arrows 472, 474 resulting in bead 480 with a center filament surrounded by helical filaments. Any number of apertures can be provided, for example, two apertures could be used to form a double helical twisted ribbon configuration.

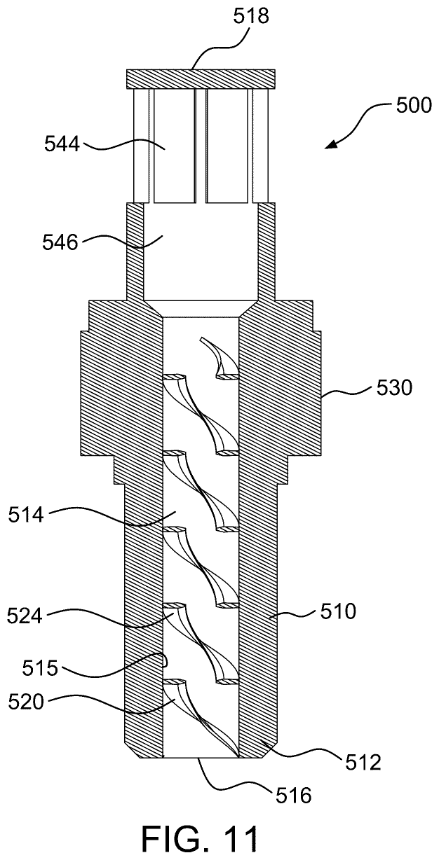

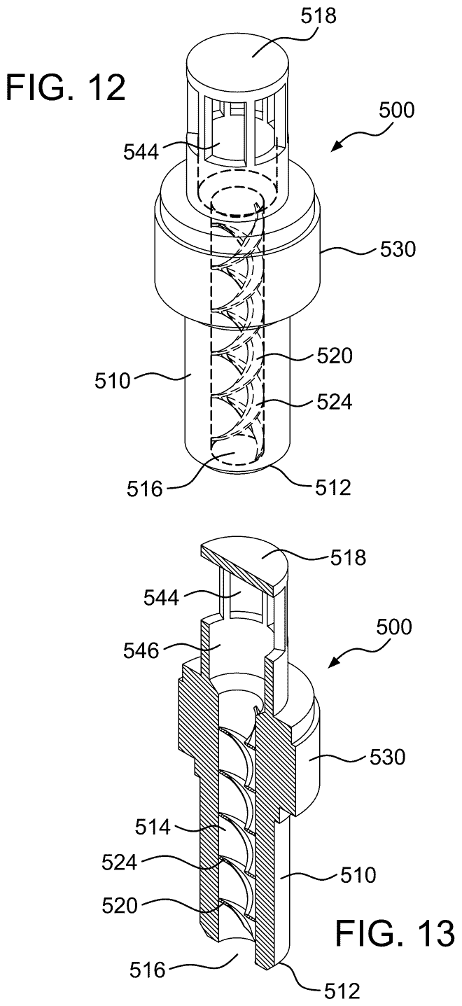

An alternative nozzle for forming a helical bead of two polymer flows is shown in FIGS. 11-17. The merging extrusion nozzle 600 includes a merging nozzle outlet fitting 500 (FIGS. 11-13). The merging nozzle outlet fitting 500 includes a sleeve 510 with an interior opening 514, a distal end 512 having a nozzle outlet opening 516, and a proximal end 518. A helical guide in the form of a double helix is secured to interior wall 515 of the sleeve 510. The double helical guide has a first helical component 520 and a second helical component 524. Openings 544 at the proximal end 518 allow a first polymer and a second polymer to enter the merging nozzle outlet fitting 500 and meet at a merging nozzle conduit 546. The merged first and second polymers flow into the open interior 514 and are guided by the double helical components into a double helical bead which is extruded through the nozzle outlet opening 516.

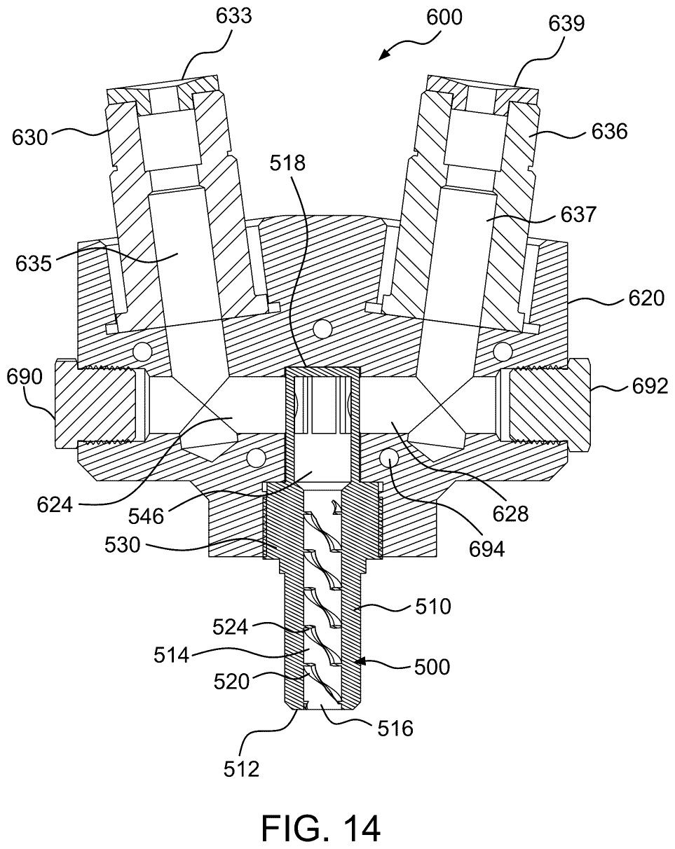

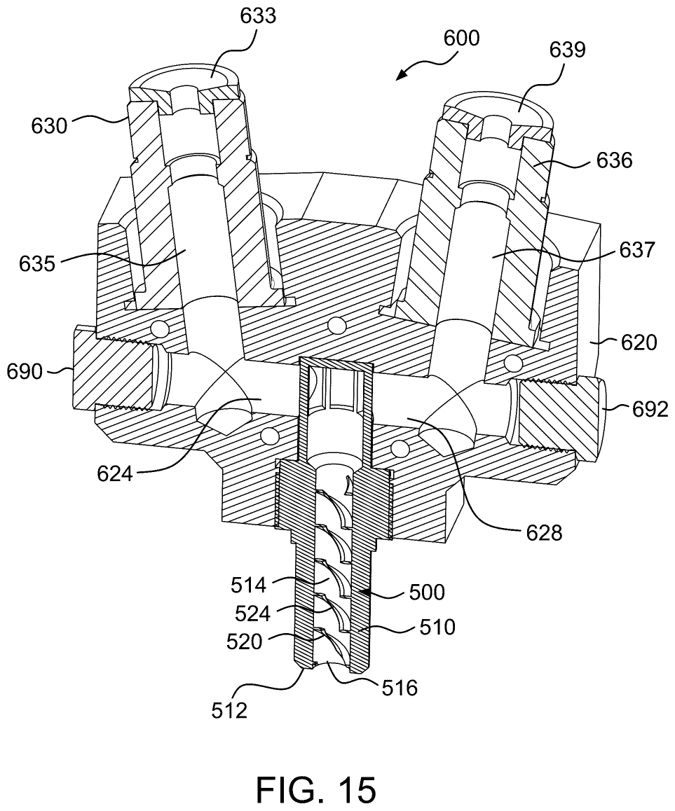

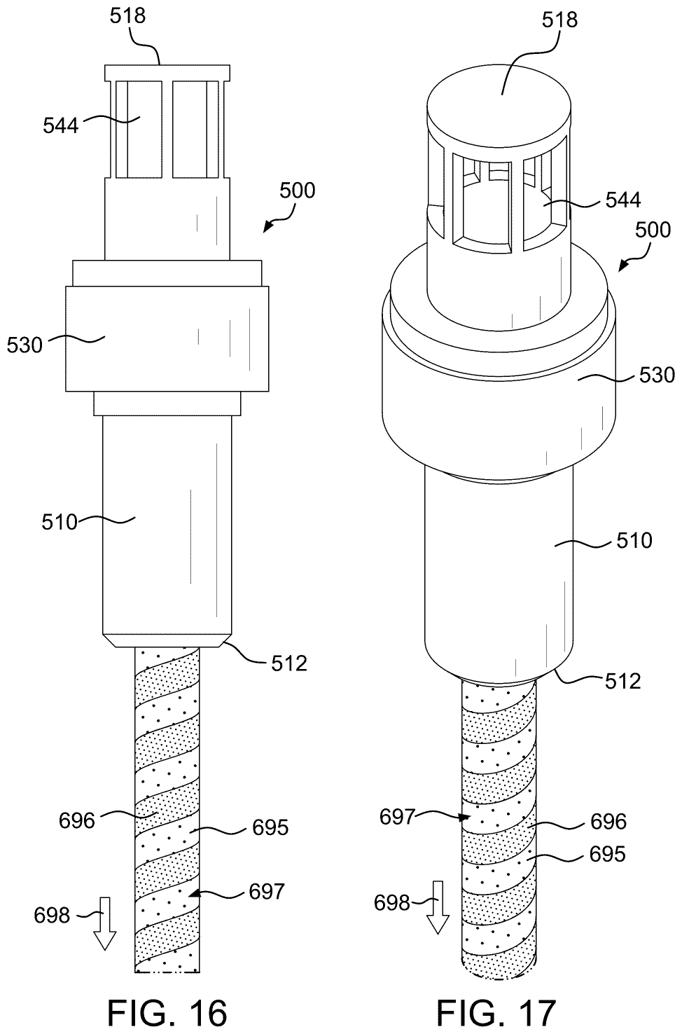

The merging extrusion nozzle 600 is shown in FIGS. 14-15. The merging extrusion nozzle 600 can have a nozzle body 620, a first connection fitting 630 and cap 633 for connecting to a first extruder (not shown) and to thereby receive a first polymer, and a second connection fitting 636 and cap 639 for connecting to a second extruder (not shown) and to thereby receive a second polymer. The first polymer flows through an interior conduit 635 of the first connection 630 and into a branch conduit 624 in the nozzle body 620. The second polymer flows through an interior conduit 637 of the first connection 636 and into a branch conduit 628 of the nozzle body 620. The first polymer and second polymer merge together in the merging nozzle conduit 546. The merging nozzle conduit 546 can be formed within the merging nozzle outlet fitting 500. The merging nozzle outlet fitting 500 can have a collar 530 which can engage the nozzle 620 by suitable structure such as cooperating threads. Additional structure such as pressure relief or access screws 690 and 692, and heating elements 694, can be provided. Flow out of the merging nozzle outlet fitting 500 is shown in FIGS. 16-17. The extruded bead 695 moves in the direction of arrow 698, and the double helical guides 520, 524 direct the first polymer 695 and the second polymer 696 into a helical band 697.

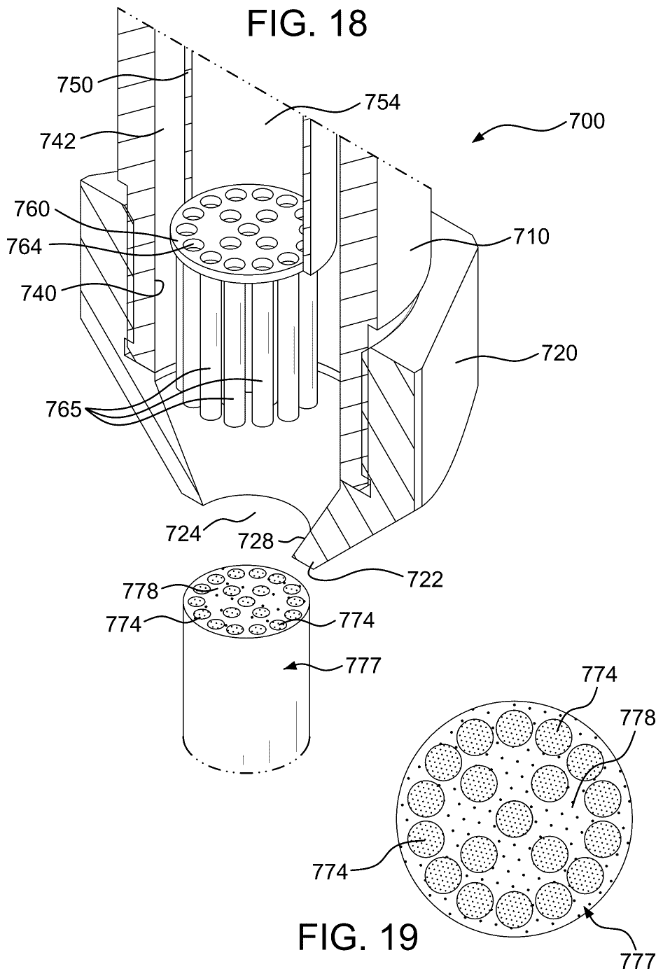

A merging nozzle outlet fitting 700 for producing beads having filaments or rods of a first polymer embedded in a second polymer is shown in FIGS. 18-19. The merging nozzle outlet fitting 700 has a sleeve 710 with a nozzle tip 720 secured thereto at a distal end. The nozzle tip 720 has a nozzle outlet opening 724 and slanted interior walls 728. The sleeve 710 has a merging nozzle conduit 742 within the sleeve 710 defined by an interior wall surface 740. A second polymer conduit 750 is positioned within the merging nozzle conduit 742 and has an open interior 754. The second polymer flow conduit 750 forms a cylindrical core within the merging nozzle conduit 742, and the annular space between the second polymer flow conduit 750 and the wall 740 form a tubular space that surrounds the interior core 754. A guide 760 is provided at a distal end of the second polymer conduit and has a plurality of forming apertures 764 communicating with flow tubes 765.

In operation, the first polymer flows through the annular space 742 and the second polymer flows through the interior space 754 of the second polymer flow conduit 750. The first polymer flows around and between the flow tubes 765. The second polymer then emerges from the flow tubes 765 as a plurality of filaments 774. The joined first polymer and second polymer can then contact a slanted or inclined wall surface 728 of the nozzle tip 720 that can further shape and size the forming bead. This action forms a finished bead 777 comprising the filaments 774 of the second polymer embedded within a matrix 778 of the first polymer. The merging nozzle outlet fitting 700 can be connected to a merging extrusion nozzle and system as previously described.

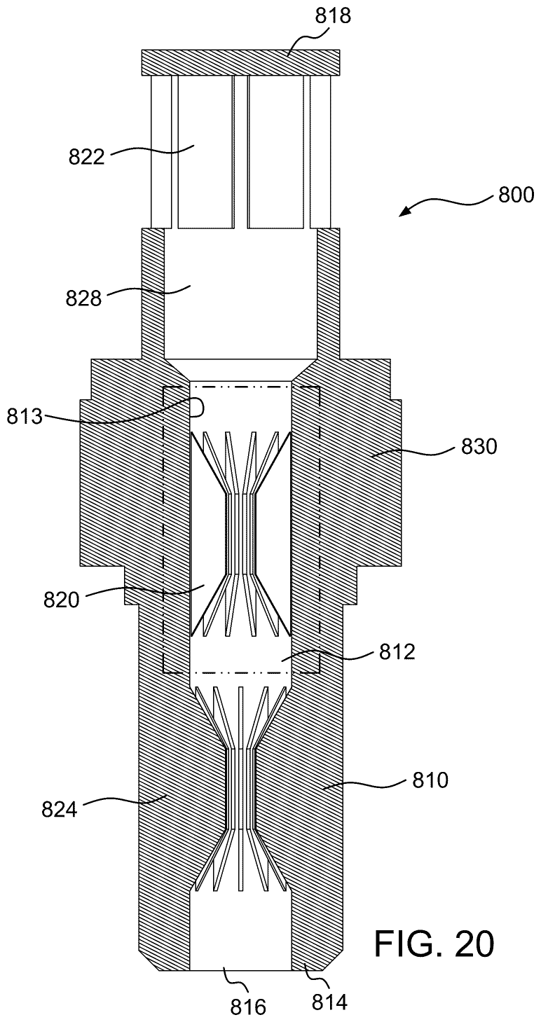

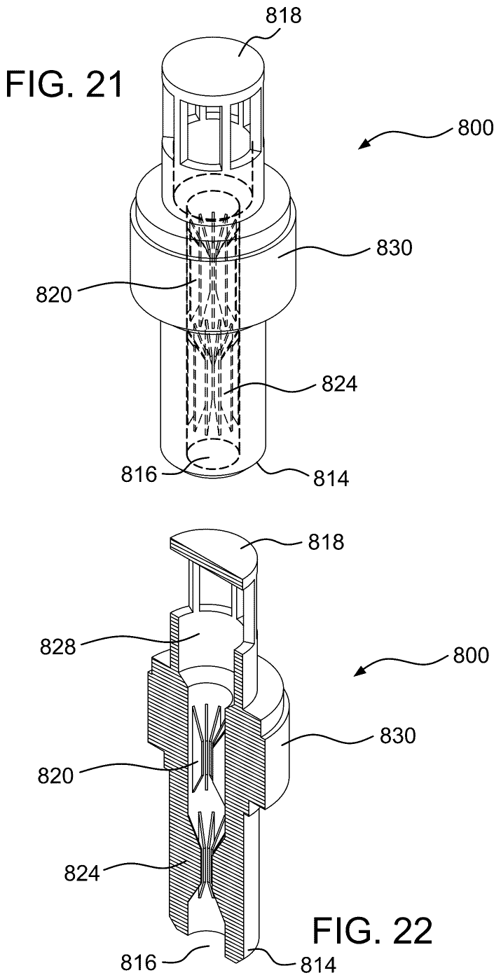

There is shown in FIGS. 20-23 a merging nozzle outlet fitting 800 that is useful for merging polymer streams which include elongated fibers that perform more optimally if aligned in the direction of extrusion of the bead. The merging nozzle outlet fitting 800 includes a sleeve 810 with an open interior 812 defined by a wall 813, and can include a collar 830 useful for attaching and detaching the merging nozzle outlet fitting 800 to a nozzle body as previously described. The merging nozzle outlet fitting 800 includes a distal end 814 with a nozzle outlet opening 816, and a proximal end 818. The merging nozzle outlet fitting 800 further comprises a plurality of polymer flow openings 822 at the proximal end 818 to receive the first and second polymer flows, which merge in a merging nozzle conduit 828. The open interior 812 includes a plurality of aligning structures 820, in this embodiment inwardly and radially oriented alignment fins 820 that are circumferentially distributed about and attached to the wall 813. A second set of alignment fins 824 can be provided downstream of the alignment fins 820. The second set can be substantially the same as the alignment fins 820 or can be different, for example more fins or less fins, closer or greater circumferential spacing between individual fins, longer or shorter, and the like. The alignment fins 820 are vertically aligned in planes that are parallel to the direction of flow of the polymer through the open interior 812.

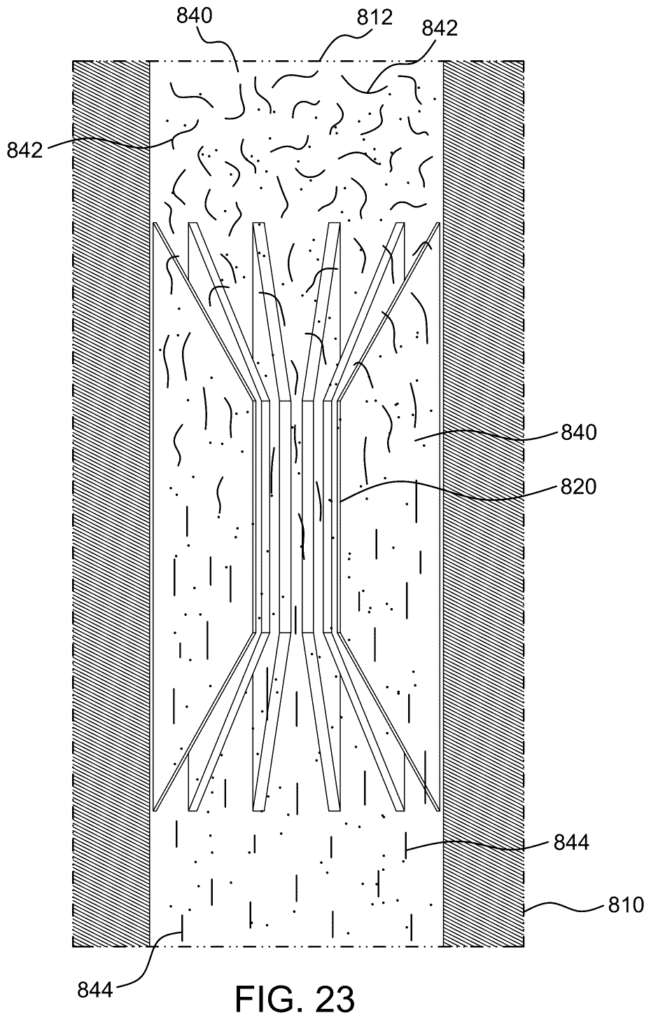

Operation of the alignment fins 820 and 824 is shown in FIG. 23. The merged polymers 840 including unaligned fibers 842 enter the open interior 812. The flow continues past the alignment fins 820, where the fibers 842 are forced between the adjacent and closely packed alignment fins 820. This action forces the alignment of the fibers into aligned fibers 844.

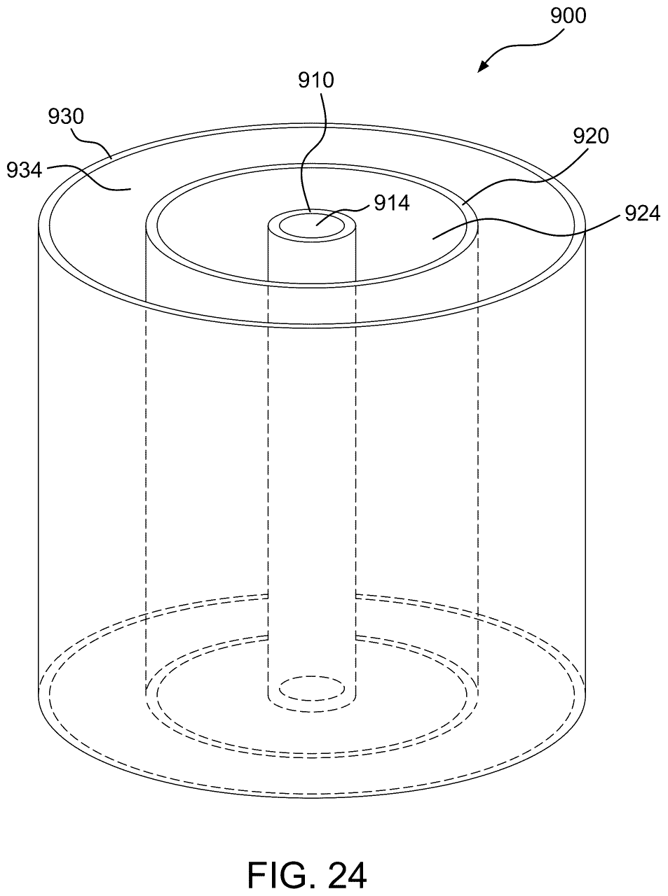

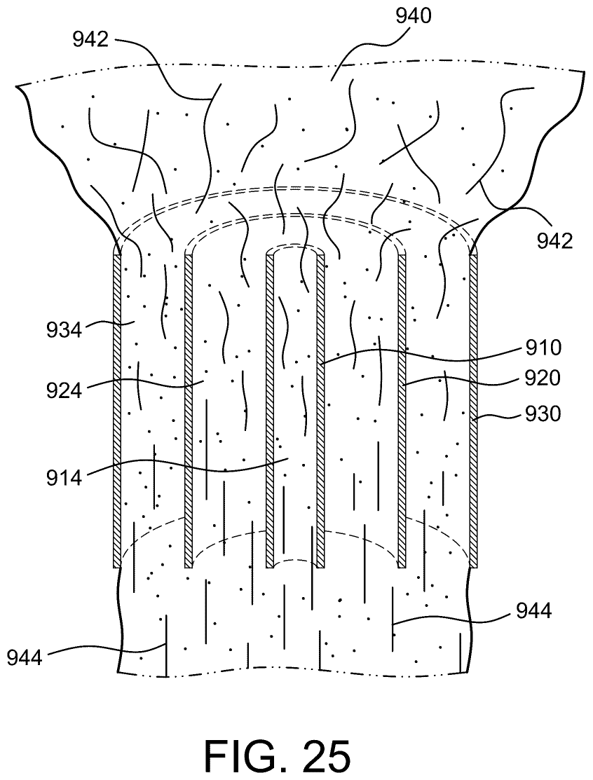

An alternative embodiment of aligning structure 900 is shown in FIGS. 24-25. The alignment structure can be positioned in the merging nozzle conduit. In this embodiment, the aligning structure comprises concentric alignment tubes. An innermost alignment tube 910 has an aligning flow passage 914. A middle alignment tube 920 forms with the innermost alignment tube 910 an annular aligning flow passage 924. An outermost alignment tube 930 forms with the middle tube 920 an annular aligning flow passage 934. In operation, as shown in FIG. 25, the aligning structure 900 is positioned in or near the merging nozzle conduit or forms a part of the merging nozzle conduit and can be mounted within a merging nozzle outlet fitting (not shown). The merged polymer material 940 includes a plurality of randomly oriented elongated fibers 942. As the polymer material 940 and randomly oriented fibers 942 flow through the aligning flow passages 914, 924 and 934, the randomly oriented fibers 942 are forced to align into aligned fibers 944.

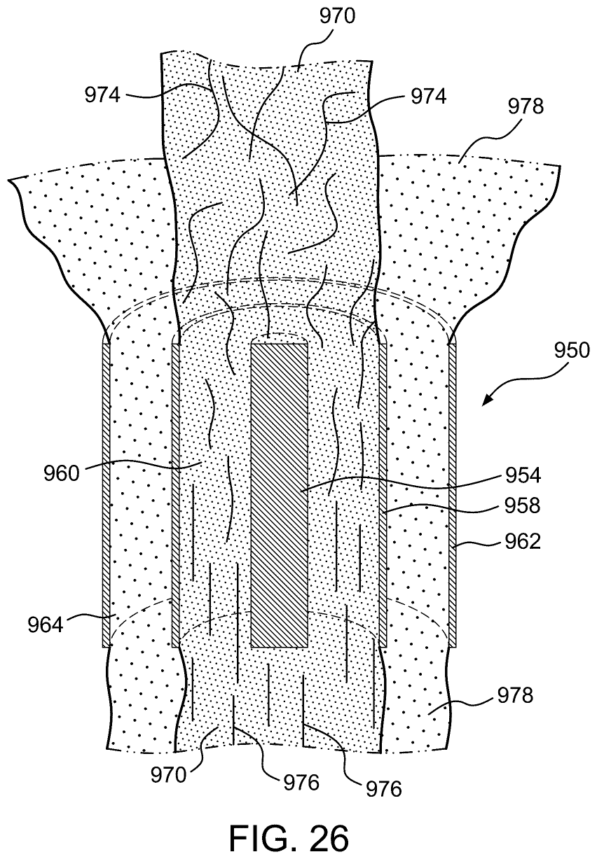

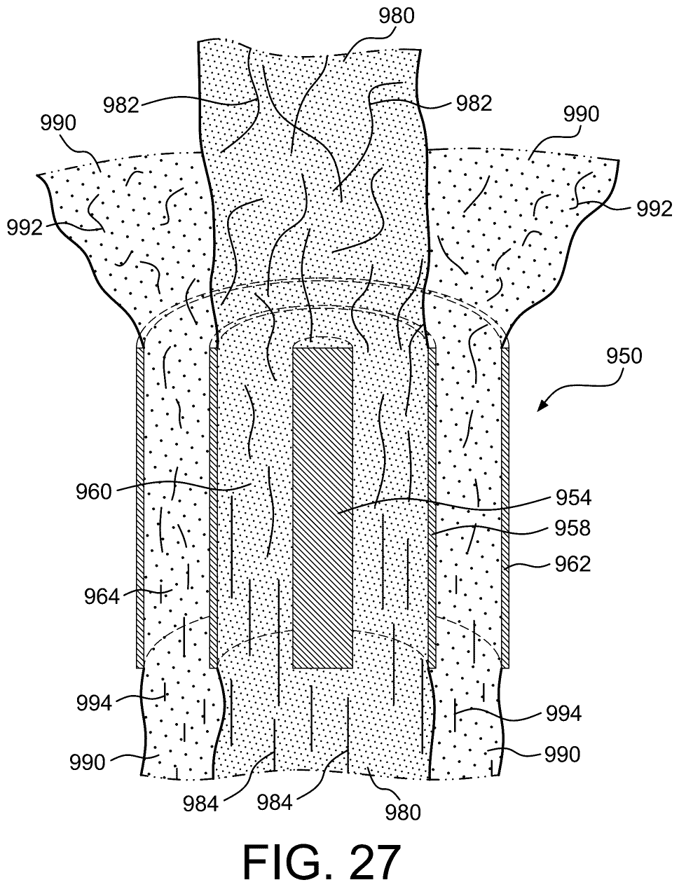

Another embodiment of aligning structure is shown in FIGS. 26-27. The aligning structure 950 includes a center post 954, an inner concentric alignment tube 958, and an outer concentric alignment tube 962. The center post 954 and inner concentric alignment tube 958 create an annular aligning flow passage 960. The inner concentric alignment tube 958 and the outer concentric alignment tube 962 create an annular aligning flow passage 964. A first polymer 970 including elongated randomly oriented fibers 974 can flow through the annular aligning space 960 and a second polymer 978 without elongated fibers can flow though the other aligning space, here the aligning space 960 (FIG. 26). The passage of the randomly oriented fibers 974 through the aligning space 960 forces the fibers to reorient as aligned fibers 976. Similarly, as shown in FIG. 27 both the first polymer 980 can have randomly oriented fibers 982 and the second polymer 990 can have randomly oriented fibers 992. The first polymer 980 and fibers 982 pass through the first aligning flow passage 960 whereupon aligned fibers 984 are produced. The second polymer 990 with fibers 992 pass through the second aligning flow passage 964 and aligned fibers 994 are produced.

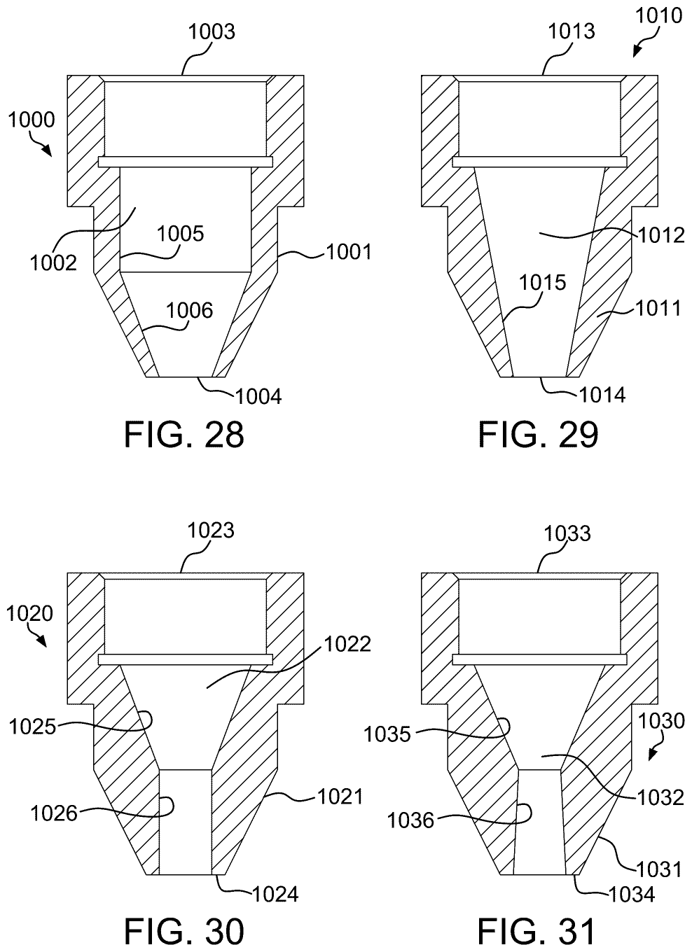

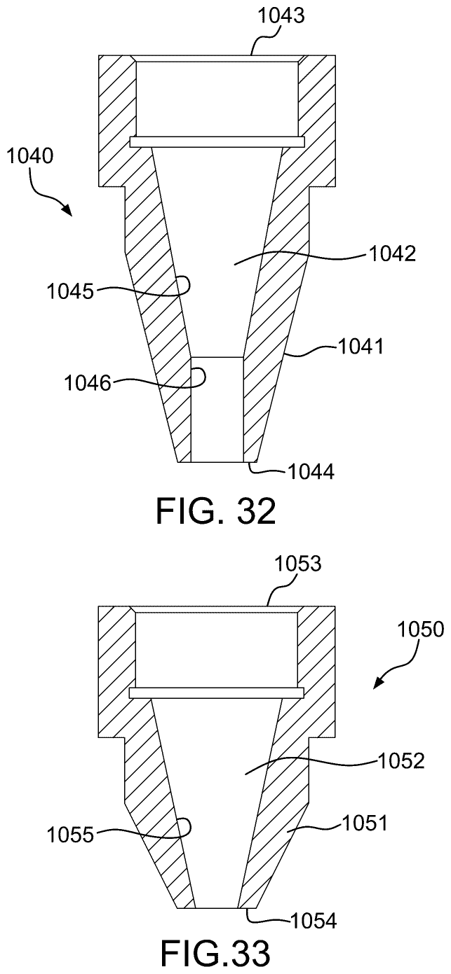

There is shown in FIGS. 28-33 differing nozzle tip designs. The nozzle tip 1000 (FIG. 28) can have side 1001, an open interior 1002, a top 1003 and a bottom 1004. The open interior 1002 is defined by a top vertical wall 1005 that joins a slanted bottom wall 1006. The nozzle tip 1010 (FIG. 29) can have sides 1011, an open interior 1012, a top 1013 and a bottom 1014. The open interior is defined by an extended significantly slanted wall 1015. The nozzle tip 1020 (FIG. 30) can have sides 1021, an open interior 1022, a top 1023 and a bottom 1024. The open interior 1022 is defined by a top slanted wall 1025 and a bottom vertical wall 1026. The nozzle tip 1030 (FIG. 31) can have sides 1031, an open interior 1032, a top 1033 and a bottom 1034. The open interior 1032 is defined by a top inwardly slanting wall 1035 and a bottom outwardly slating wall 1036. The nozzle tip 1040 (FIG. 32) can have sides 1041, an open interior 1042, a top 1043 and a bottom 1044. The open interior can be defined by an elongated top slating wall 1045 which transitions to a bottom vertical wall 1046. The nozzle tip 1050 (FIG. 33) can have sides 1051, an open interior 1052, a top 1053 and a bottom 1054. The open interior is defined by an elongated slightly slanted wall 1055.

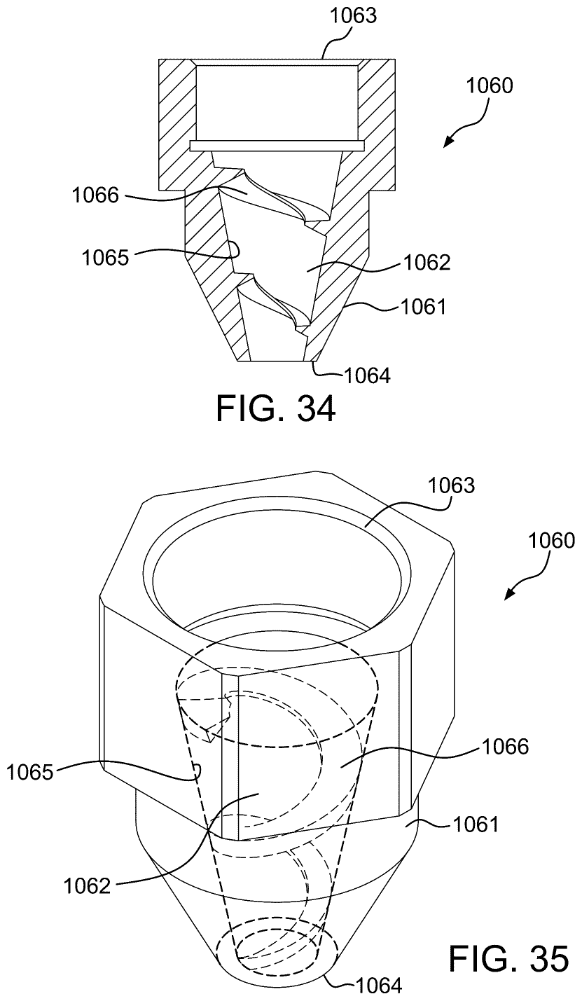

There is shown in FIGS. 34-35 a nozzle tip 1060 having a helical guide element. The nozzle tip 1060 has sides 1061, an open interior 1062, a top 1063 and a bottom 1064. The open interior 1062 is defined by a slanted wall 1065. A helical guide element 1066 is provided to twist the polymer into a helix as it is extruded.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A multi material extrusion system, comprising:
a first polymer extruder configured to extrude a first polymer, and a second polymer extruder configured to extrude a second polymer;
a nozzle comprising a first polymer inlet in fluid connection with the first extruder, a second polymer inlet in fluid connection with the second extruder, and a merging nozzle conduit having a merging nozzle conduit surface, the merging nozzle conduit terminating in a merging nozzle conduit outlet opening;
the nozzle further comprising a first polymer flow conduit in fluid communication with the first polymer inlet and a second polymer flow conduit in fluid communication with the second polymer inlet; and,
the first polymer flow conduit being configured to deliver the first polymer to the merging nozzle conduit and the second polymer flow conduit being configured to deliver the second polymer to the merging nozzle conduit, to create a multi-material bead comprising the first polymer in contact with the second polymer.

2. The multi material extrusion system of claim 1, wherein the second polymer is different from the first polymer.

3. The multi material extrusion system of claim 1, wherein at least one of the first polymer and second polymer comprise elongated fibers.

4. The multi material extrusion system of claim 3, further comprising fiber alignment structure in the merging nozzle conduit for aligning the elongated fibers in a common direction.

5. The multi material extrusion system of claim 4, wherein the alignment structures comprise elongated baffles affixed to the merging nozzle conduit surface and aligned in a direction of flow of the first polymer and second polymer through the merging nozzle conduit.

6. The multi material extrusion system of claim 4, wherein the alignment structures comprise concentric flow channels within the merging nozzle conduit and aligned in a direction of flow of the first polymer and the second polymer through the merging nozzle conduit.

7. The multi material extrusion system of claim 1, further comprising a processor.

8. The multi material extrusion system of claim 1, further comprising a first polymer source in communication with the first polymer extruder, and a second polymer source in fluid communication with the second polymer extruder.

9. The multi material extrusion system of claim 8, wherein the first polymer source and the second polymer source are containers adapted for polymer pellets.

10. The multi material extrusion system of claim 1, wherein the first polymer flow passageway, the second polymer flow passageway and the merging nozzle conduit are Y-shaped.

11. The multi material extrusion system of claim 1, wherein the first polymer flow passageway, the second polymer flow passageway and the merging nozzle conduit are T-shaped.

12. The multi material extrusion system of claim 1, wherein the nozzle comprises a nozzle block comprising the first polymer flow conduit, the second polymer flow conduit, and the merging nozzle conduit, the nozzle further comprising a nozzle tip comprising the nozzle tip opening, the nozzle tip being fixed to the nozzle block so as to place the nozzle tip opening in fluid communication with the merging nozzle conduit outlet opening.

13. The multi material extrusion system of claim 11, wherein the nozzle tip is detachable from the nozzle block.

14. The multi material extrusion system of claim 11, wherein the nozzle tip is rotatable relative to the nozzle block.

15. The multi material extrusion system of claim 1, wherein the first polymer flow passageway and the second polymer flow passageway transition to concentric outlet polymer flow passageways at the merging nozzle outlet.

16. The multi material extrusion system of claim 1, wherein the first polymer flow passageway and the second flow passageway transition to concentric outlet polymer passageways with the first outlet polymer passageway surrounding the second outlet polymer passageway, and the second outlet polymer passageway terminates in a forming plate comprising a plurality of flow openings communicating with flow tubes such that polymer rods of the second polymer are formed as the second polymer passes through the flow tubes, and the first polymer flows from the first outlet polymer passageway around the flow tubes to form a filament of the first polymer with embedded rods of the second polymer at the merging nozzle outlet opening.

17. The multi material extrusion system of claim 1, further comprising a first helical guide affixed to the merging nozzle conduit surface for directing at least one of the first polymer and the second polymer in a helical path through the merging nozzle conduit.

18. The multi material extrusion system of claim 17, further comprising a second helical guide affixed to the merging nozzle conduit surface and arranged relative to the first helical guide in a double helical configuration.

19. The multi material extrusion system of claim 1, wherein the nozzle comprises a rotating nozzle tip, the nozzle tip comprising a nozzle tip conduit in fluid communication with the merging nozzle conduit outlet opening, the nozzle tip further comprising a guide plate fixed within the nozzle tip conduit so as to rotate with the nozzle tip, the guide plate comprising a plurality of guide openings.

20. A method of multi plexing extrusion, comprising the steps of:
providing a first polymer extruder configured to extrude a first polymer, and a second polymer extruder configured to extrude a second polymer; a nozzle comprising a first polymer inlet in fluid connection with the first extruder, a second polymer inlet in fluid connection with the second extruder, and a merging nozzle conduit having a merging nozzle conduit surface, the merging nozzle conduit terminating in a merging nozzle conduit outlet opening; the nozzle further comprising a first polymer flow conduit in fluid communication with the first polymer inlet and a second polymer flow conduit in fluid communication with the second polymer inlet;
delivering the first polymer to the first polymer flow conduit and to merging nozzle conduit from the first extruder;
delivering the second polymer to the second polymer flow conduit and to the merging nozzle conduit from the second extruder;
creating in the merging nozzle conduit a multi-material bead comprising the first polymer and the second polymer.

21. The method of claim 20, further comprising the step of embedding the second polymer in the first polymer.

22. The method of claim 20, further comprising the step of using a processor to control the positioning of the nozzle and the operation of the first polymer extruder and the second polymer extruder.

23. The method of claim 20, wherein the multi plexing extrusion is at least one selected from the group consisting of additive manufacturing, profile extrusion, additive manufacturing-compression molding (AMCM) processes, extrusion-compression molding processes, film and sheet extrusion processes, and blow molding processes.

24. The method of claim 20, wherein the merging nozzle conduit receive polymer from at least 3 extruders.
